(19) United States
(12) Patent Application Publication
(10) Pub. No.: US 2026/0121573 A1
(43) Pub. Date: Apr. 30, 2026

(54) HYBRID POWER GENERATION SYSTEM

(71) Applicant: Holtec International, Camden, NJ (US)

(72) Inventors: Krishna P. SINGH, Jupiter, FL (US); Edward BELL, Medford, NJ (US); Indresh RAMPALL, Cherry Hill, NJ (US)

(73) Assignee: Holtec International, Camden, NJ (US)

(21) Appl. No.: 19/373,557

(22) Filed: Oct. 29, 2025

Related U.S. Application Data
(60) Provisional application No. 63/713,314, filed on Oct. 29, 2024.
(60) Provisional application No. 63/720,918, filed on Nov. 15, 2024.

(51) Int. Cl. H02S 10/10; G21C 1/08; G21D 3/12; H02S 10/20; H02S 40/22

(52) U.S. Cl. CPC H02S 10/10; G21C 1/086; G21D 3/12; H02S 10/20; H02S 40/22

(57) ABSTRACT

A hybrid power generation system which includes a nuclear facility comprising a nuclear reactor and an exclusion zone. A thermal energy storage, a nuclear steam supply system located, and a solar energy collection system are all located within the exclusion zone. The thermal energy storage vessel contains a thermal mass composition operable to store thermal energy. The nuclear steam supply system has a nuclear reactor and a working fluid loop. The working fluid loop is configured to circulate a working fluid from a steam generator through the thermal energy storage vessel to absorb thermal energy and heat the working fluid for introduction to an electricity generating system. The solar energy collection system includes a heat transfer loop heated via a solar collector. The heat transfer loop is configured to circulate a heated heat transfer fluid to add thermal energy to the thermal mass composition in the thermal energy storage vessel.

### CROSS-REFERENCE TO RELATED APPLICATIONS

The present application claims the benefit of priority to U.S. Provisional Application No. 63/713,314, filed on Oct. 29, 2024, and U.S. Provisional Application No. 63/720,918, filed on Nov. 15, 2024, which is incorporated herein by reference in its entirety.

### FIELD OF THE INVENTION

The present invention relates to systems for producing electric power, and more particularly to a combined solar and nuclear steam supply system which utilizes solar energy to boost the enthalpy of steam produced in nuclear steam supply system for generating electric power via the Rankine cycle.

### BACKGROUND OF THE INVENTION

Thermal energy reaching earth from the sun is quite immense. Yet, harnessing it for useful purposes has been difficult. For over 200 years, fossil fuels excavated from the ground have been the mainstay for energy supply needed to support human civilization. Solar energy, although ubiquitous and visibly strong between the equatorial and subtropical regions of the earth (between the lines of Cancer and Capricorn), drew little attention until the late 20th century when the nexus between the carbon spewed into the environment by burning of fossil fuels and global climate disruption became impossible to ignore. Solar energy generation, long an object of scant scientific work, now has been vaulted into a central area of academic and industrial research.

Nuclear power plants present an alternative power generation technology to solar which also does not contribute to carbon pollution. Small modular reactors (SMRs) have a small footprint and can be more readily sited than traditional large scale nuclear plants of the past. Such SMRs produce the steam necessary to generate power via a traditional Rankine cycle using a turbine-generator set (also referenced to as a turbogenerator in the art for short). However, these nuclear steam supply systems produce steam at a relatively modest pressure and temperature as shown in Table 1 below, thereby limiting the electric power output which can be extracted from the steam via the Rankine cycle.

TABLE 1
Key System Design Data for Typical Light Water Reactors

| Parameter | SMR-300 | NuScale¹ | B&W-177² | AP1000³ | GE BWR⁴ | BWRX-300⁵ |
|---|---|---|---|---|---|---|
| Thermal Power | 1050 | 250 | 2772 | 3400 | 3293 | 870 |
| (MW) | | | | | | |
| Gross Electric | 385 | 77 | 911 | 1250 | 1117 | ~300 |
| Power (MW) | | | | | | |
| RCS Pressure | 2250 | 2000 | 2200 | 2250 | 1035 | 1040 |
| (psia) | | | | | | |
| RCS Core Exit | 612 | 598 | 608 | 610 | 549 | 550 |
| Temperature (F.) | | | | | | |
| RCS Core Inlet | 549 | 482 | 557 | 537 | 532 | 518 |
| Temperature, T- | | | | | | |
| hot (F.) | | | | | | |
| Main Steam | 900 | 475 | 925 | 836 | 1020 | 1040 |
| Pressure (psia) | | | | | | |
| Main Steam | 590 | 537 | 593 | 523 | 547 | 550 |
| Temperature (F.) | | | | | | |
| Main Steam | 58 | 76 | 58 | Saturated | Saturated | Saturated |
| Superheat (F.) | | | | | | |

A system is needed which can boost the enthalpy of steam produced by SMRs in an environmentally benign manner using renewable power such as solar or wind. Increasing the enthalpy of the steam supply, which is a property related to the internal energy of a system based on pressure and temperature, would enable the electric power output of the generating plant to be enhanced.

### SUMMARY OF THE INVENTION

A hybrid power generation system and related methods are disclosed for increasing the enthalpy of the steam produced by the nuclear steam supply system by using intermittently available energy collected from renewables, such as wind and solar in particular. By increasing the temperature and pressure of the steam (i.e. enthalpy), the electric power output from the hybrid power generation system can be increased via the higher energy steam supply. In one embodiment disclosed herein, the hybrid power generation system combines solar energy and a nuclear steam supply system in a single power plant. The hybrid plant can serve as a base load power plant or one that is used as a peaking generating unit to meet increased intermittent load demands on the electric power grid. Also disclosed is a system and method for converting fossil fuel power plants to a “green” hybrid power generator system.

In one aspect the invention is a hybrid power generation system comprising a nuclear facility comprising a nuclear reactor and an exclusion zone, a thermal energy storage vessel, a nuclear steam supply system, and a solar energy collection system. The thermal energy storage vessel is located within the exclusion zone and defines an internal space containing a thermal mass composition operable to store thermal energy. The nuclear steam supply system is also located within the exclusion zone and comprises the nuclear reactor and a working fluid loop. The working fluid loop comprises a steam generator, and an electricity generating system. The working fluid loop is configured to circulate a working fluid from the steam generator through the thermal energy storage vessel to absorb thermal energy from the thermal mass composition and heat the working fluid for introduction to the electricity generating system. The solar energy collection system is further located within the exclusion zone and comprises a heat transfer loop including a first solar collector configured to absorb solar energy to heat a heat transfer fluid. The heat transfer loop is configured to circulate the heated heat transfer fluid through the thermal energy storage vessel to add thermal energy to the thermal mass composition in the thermal energy storage vessel.

In another aspect, the invention is a hybrid power generation system comprising a nuclear steam supply system comprising a nuclear reactor, an exclusion zone surrounding the nuclear reactor, and a solar energy collection system located within the exclusion zone. The nuclear steam supply system further has a working fluid loop including a steam generator and an electricity generating system. The solar energy collection system is configured to collect solar energy and transfer the solar energy as thermal energy to the working fluid loop via a heat transfer fluid. The solar energy collection system comprises a tower comprising a first receiver and a second receiver. The first receiver and the second receiver are configured to receive the solar energy and heat the heat transfer fluid. The first receiver is located at a first height along the tower and the second receiver is located at a second height.

According to another aspect of this invention, the hybrid power generation system includes a thermal energy storage vessel, an alternative energy collection system, a nuclear steam supply system, and a control system. The thermal energy storage system defines an internal space containing a thermal mass composition operable to store thermal energy. The alternative energy collection system is configured to collect an alternative energy and transfer the alternative energy to the thermal mass composition in the thermal energy storage as thermal energy to heat the thermal mass composition. The nuclear steam supply system includes a nuclear reactor and a working fluid loop comprising a steam generator and an electricity generating system The working fluid loop is configured to circulate a working fluid and comprises a heat transfer line having a portion located within the thermal energy storage vessel and in thermal communication with the thermal mass composition and a bypass line that bypasses the thermal energy storage vessel. The heat transfer line is configured to deliver the working fluid that passes through the portion to the electricity generating system. The control system configured to selectively switch the working fluid from flowing through the heat transfer line to flowing through the bypass line.

Another aspect of the invention is a hybrid power generation system including a thermal energy storage vessel, an alternative energy collection system, and a nuclear system supply system. The thermal energy storage vessel defines an internal space containing a thermal mass composition operable to store thermal energy. The alternative energy collection system configured to collect an alternative energy and transfer the alternative energy to the thermal mass composition in the thermal energy storage as thermal energy to heat the thermal mass composition. The nuclear steam supply system comprises a nuclear reactor and a working fluid loop that comprises a steam generator and an electricity generating system. The working further comprises a flow splitter, a first heat transfer line, and an auxiliary line. The flow splitter is configured to divide flow of the working fluid downstream of the steam generator but upstream of the thermal energy storage vessel into a first working fluid stream and a second working fluid stream. The first heat transfer line is configured to: (i) receive the first working fluid stream; (ii) flow the first working fluid stream through the thermal energy storage vessel so that the first working fluid stream absorbs thermal energy from the thermal mass composition; and (iii) deliver the first working fluid stream exiting the thermal energy storage vessel to the electricity generating system. The auxiliary line is configured to receive the second working fluid steam.

### BRIEF DESCRIPTION OF THE DRAWINGS

The features of the exemplary embodiments of the present invention will be described with reference to the following drawings, where like elements are labeled similarly, and in which:

FIG. 1 is a top schematic view of a nuclear steam supply system showing an exclusion zone around the nuclear reactor of the nuclear steam supply system;

FIG. 2 is a top schematic view of a hybrid power generation system according to a first embodiment of the invention;

FIG. 3 is a side schematic view of the hybrid power generation system of FIG. 2;

FIG. 4 is a top schematic view of a hybrid power generation system according to a second embodiment of the invention;

FIG. 5 is a side schematic view of the hybrid power generation system of FIG. 4;

FIG. 6 is a schematic flow diagram of a hybrid power generation system including a solar energy collection system, a power generation system, nuclear steam supply system, and thermal energy storage system;

FIG. 7 is a schematic flow diagram of an alternative embodiment of the hybrid power generation system of FIG. 6; and

FIG. 8 is a schematic flow diagram further alternative embodiment of the hybrid power generation system of FIG. 6.

All drawings are schematic and not necessarily to scale. Parts given a reference numerical designation in one figure may be considered to be the same parts where they appear in other figures without a numerical designation for brevity unless specifically labeled with a different part number and described herein. Any reference herein to a whole figure number herein which may comprise multiple figures with the same whole number but different alphabetical suffixes shall be construed to be a general reference to all those figures sharing the same whole number, unless otherwise indicated.

### DETAILED DESCRIPTION OF THE EMBODIMENTS

The features and benefits of the invention are illustrated and described herein by reference to exemplary (“example”) embodiments. This description of exemplary embodiments is intended to be read in connection with the accompanying drawings, which are to be considered part of the entire written description. Accordingly, the disclosure expressly should not be limited to such exemplary embodiments illustrating some possible non-limiting combination of features that may exist alone or in other combinations of features.

In the description of embodiments disclosed herein, any reference to direction or orientation is merely intended for convenience of description and is not intended in any way to limit the scope of the present invention. Relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

As used throughout, any ranges disclosed herein are used as shorthand for describing each and every value that is within the range. Any value within the range can be selected as the terminus of the range. In addition, all references cited herein to prior patents or patent applications are hereby incorporated by reference in their entireties. In the event of a conflict in a definition in the present disclosure and that of a cited reference, the present disclosure controls.

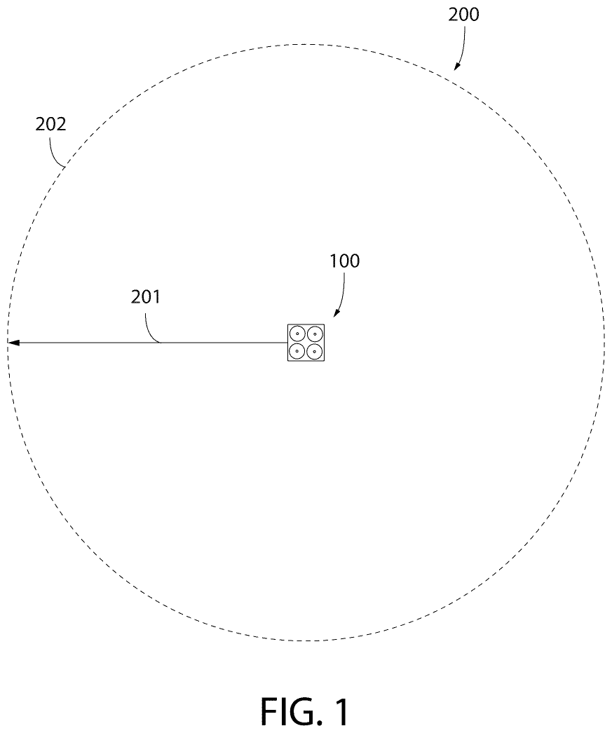

FIG. 1 illustrates a nuclear facility 100 according to the present disclosure. The land around the nuclear facility 100 may be set aside as an exclusion zone 200. The exclusion zone is the immediately surrounding the nuclear facility 100 where the licensee of the nuclear facility 100 has the authority to determine all activities including the exclusion or removal of personnel and property. In the exemplified embodiment, the exclusion zone 200 may be a circular area with a radius that extends from the nuclear facility 100 to the perimeter of the exclusion zone 202. Of course, the exclusion zone 200 may have any other suitable cross-sectional shape such as a rectangular, square, or regular polygon, or non-regular polygon shape sufficient to distance the nuclear facility 100 from surrounding population centers.

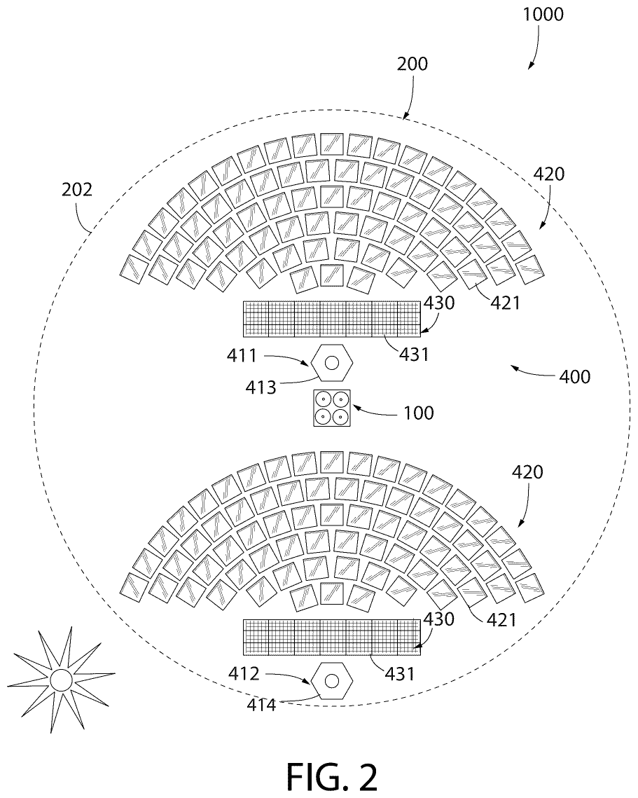

FIGS. 2-8 illustrate a hybrid power generation systems 1000, 2000, and 3000 according to the present disclosure. The first of these systems, hybrid power generation system 1000 is discussed immediately below. In the exemplified embodiment, the hybrid power generation system 1000 may comprise the nuclear facility 100, a nuclear steam supply system 105, the exclusion zone 200, a thermal energy storage vessel 300, and a solar energy collection system 400. The details of each of these components of the hybrid power generation system 1000 will be discussed at greater length below.

The thermal energy storage vessel 300 will now be described in further detail. In the exemplified embodiment, the thermal energy storage system 300 comprises an internal cavity 310 containing a thermal mass composition M specially configured and operable to absorb heat energy from the solar energy collection system 400 and in turn yield the stored heat energy on demand to heat steam generated by the nuclear steam supply system 100. This advantageously boosts the enthalpy (i.e. energy) of the steam to generate more power than if using steam output at its usual conditions from the nuclear steam supply system 100 at a lower enthalpy with more modest temperature and pressure.

The thermal energy storage vessel 300 operably and thermally couples the solar energy collection system 400 and nuclear steam supply system 105 together, as further described herein. In the exemplified embodiment, the nuclear steam supply system 105 and the solar energy collection system 400 are fluidly isolated from each other such that the enthalpy is not directly transferred between the nuclear steam supply system 105 and the solar energy collection system 400. Rather, the thermal energy storage vessel 300 serves as an intermediate component that allows enthalpy to be transferred from the solar energy storage collection system 400 to the nuclear steam supply system 105, and visa versa.

The thermal energy storage vessel 300 may be suitably sized to store the thermal energy from the nuclear steam supply system 105 during periods of low demand obviating the need for (inefficient) load-following. The nuclear steam supply system 105 can thus be continuously operated at full power at all times and thermal energy storage vessel 300 serves as a massive thermal capacitor delivering the amount of power as needed to meet the concomitant consumption. The use of fossil-powered “peakers” can be discontinued and their associated Carbon emission eliminated.

Thermal mass composition M will now be further described. Any suitable thermal mass composition M may be used which can be customized and selected for the required thermal duty and operating parameters needed for heating the heat transfer fluid (which may be water/water mixtures or other fluids) from an inlet temperature entering the thermal energy storage vessel 300 to a desired outlet temperature. In one illustrated embodiment, without limitation, the thermal mass composition may be a mixture comprising at least one first base metallic material mixed with a second phase change material (PCM). Both the base metallic material(s) and PCM of the thermal mass composition mixture may be in a granular particle form (i.e. a solid) at ambient temperatures which is flowable to fill an internal cavity 335 of the thermal energy storage vessel via openable/closeable fill ports through the vessel housing 334. Both the base metallic material(s) and PCM are materials having properties configured to produce a thermal mass operable to absorb and store heat, and release that heat on demand when required to heat the heat transfer fluid flowing through tubes 311 a each heat exchanger 331.

Preferably, the at least one base metallic material may constitute a majority of the mixture or composition and has a higher melting point or temperature Tbm than the melting point or temperature Tpcm of the PCM. Temperature Tpcm is preferably lower than the normal operating temperature Tnm of the thermal mass composition M to which the mass will be heated for normal operation such that the PCM melts and changes to a liquid or molten state when the thermal mass is heated. At ambient temperatures, the PCM is in a solid particle state.

By contrast, the at least one base metallic material preferably has a melting temperature Tbm greater than the normal operating temperature Tmm, and preferably greater than the maximum temperature Tmax of the thermal mass composition when heated by the heaters such that the base metallic material always remains in a solid particle state whether the heaters are fully energized or offline. In some representative but non-limiting examples, the base metallic material may have a melting temperature Tbm greater than 1,000 degrees C. (Celsius), or greater than 2,000 degrees C. in some embodiment, whereas the PCM may have a melting temperature Tpcm less than 1,000 degrees C. The metallic material may comprise a single one or a combination of ferrous and/or non-ferrous metal particles selected to optimize heat retention capabilities and meeting the foregoing melting temperature criteria.

In use to store thermal energy, the thermal energy storage vessel 300 (i.e. internal cavity 335) is first filled with the thermal mass composition M to a final elevation or level that at least covers the highest or uppermost heaters in the vessel. Both the at least one base metallic material and PCM are in a solid granular particle state at ambient temperatures before the thermal mass is heated by electric heaters. The initially “off” heaters are then energized, which heats the entire bed of thermal mass composition M to its normal operating temperature Tnm (which may be less than its maximum temperature Tmax in some cases). While the at least one base metallic material remains in solid granular particle form, the PCM will melt thereby flowing and filling the interstitial spaces/voids between the base metallic material particles. This advantageously results in more efficient and complete heating of the thermal mass composition M than if all metallic material were used because air-filled pockets or voids between the material particles is filled with a conductive liquid PCM, thereby increasing the heat retention properties of the thermal mass. Thought of another way, this might be considered somewhat analogous to wetted sand in which water fills voids between the sand particles. The melted PCM in combination with the still solid base metallic material particles further allows the thermal mass composition mixture to enhance conformal contact with both the heating elements of heaters and the outer surfaces of the heat transfer tubes 311 of each heat exchanger 331 which further benefits heat transfer. When the heat input is removed from the thermal mass composition by de-energizing the heaters, the PCM will return to a solid state.

In preferred but non-limiting embodiments, the PCM used may be a salt which may be converted from a granular solid particle state at ambient temperatures to a liquid/molten state when heated by electric immersion heaters when energized by electric power extracted from an available power source such as the electric power grid or another source. Any suitable salt may be used which is selected for the required thermal duty.

Some examples of salts which may be used to form the PCM bed in each thermal energy storage vessel 300 are shown in the following table:

| Tₘₑₗₜ | | Latent Heat |
|---|---|---|
| (° C.) | Material | (kJ/kg) |
| 94 | 60 wt % AlCl₃ + 14% KCl + 26% NaCl | 213 |
| 150 | 66 wt % AlCl₃ + 34% NaCl | 201 |
| 202 | 7.5 wt % NaCl + 23.9% KCl + 68.6% ZnCl₂ | 200 |
| 258 | 59 wt % NaOH + 41% NaNO₃ | 292 |
| 307 | NaNO₃ | 177 |
| 318 | 77.2 mol % NaOH − 16.2% NaCl − 6.6% Na₂CO₃ | 290 |
| 320 | 54.2 mol % LiCl − 6.4% BaCl₂ − 39.4% KCl | 170 |
| 335 | KNO₃ | 88 |
| 340 | 52 wt % Zn − 48% Mg | 180 |
| 348 | 58 mol % LiCl − 42% KCl | 170 |
| 370 | 26.8% NaCl − 73.2% NaOH | 320 |
| 380 | KOH | 149.7 |
| 380 | 45.4 mol % MgCl₂ − 21.6% KCl − 33% NaCl | 284 |
| 381 | 96 wt % Zn − 4% Al | 138 |
| 397 | 37 wt % Na₂CO₃ − 35% K₂CO₃ − 31% Li₂CO₃ | 275 |
| 430 | 56 wt % NaCl − 44% MgCl₂ | 168 |
| 443 | 59 wt % Al − 35% Mg − 6% Zn | 310 |
| 450 | 48 wt % NaCl − 52% MgCl₂ | 430 |
| 470 | 36 wt % KCl − 64% MgCl₂ | 388 |
| 487 | 56 wt % Na₂CO₃ − 44% Li₂CO₃ | 368 |
| 500 | 33 wt % NaCl − 67% CaCl₂ | 281 |
| 550 | LiBr | 203 |
| 632 | 46 wt % LiF − 44% NaF₂ − 10% MgF₂ | 858 |
| 658 | 44.5 wt % NaCl − 55.5% KCl | 388 |
| 714 | MgCl₂ | 452 |
| 801 | NaCl | 510 |

The melt temperatures and latent heat properties of the salt are properties and factors which direct the selection of the type salt for the required thermal duty and temperature increase of the heat transfer fluid. It bears noting that the type of salt used in each thermal energy storage vessel 300 may therefore be customized and different. Regardless of the application including simply heating water for district heating or other applications, it is apparent to those skilled in the art that thermal duty and performance of the thermal energy storage vessel 300 is highly customizable to meet the required temperature increase objectives of the thermal energy system.

It bears noting that any suitable PCM may be used other than the salts such as those listed above may be used so long as the melting temperature Tpcm of the PCM is less than the normal operating temperature) of the thermal mass composition during operation of the thermal energy storage vessel 300 when the heaters are energized.

Although the thermal energy storage vessel 300 disclosed herein may have been described without limitation for further heating steam (second working fluid) output by the nuclear steam supply system 105 to increase enthalpy (e.g., temperature) via the thermal mass composition M bed, the invention is not limited in this regard. Accordingly, the thermal energy storage vessel 300 may be used to heat any other types of fluids which are flowable through the heat exchanger tubes 311 of the thermal energy storage vessel 300. Accordingly, numerous applications of the “green” thermal energy storage system 300 are possible and within the scope of the present disclosure.

The thermal energy storage vessel 300 may specifically be a green boiler. Features of the green boiler which stores and releases thermal energy on demand can be summarized as including the following. The green boiler is a modular thermal storage device that can store vast quantities of heat energy in a specially engineered material called Feorite™ which has a high specific heat and thermal capacity and contains a eutectic that has a high latent heat of fusion. The green boiler is a prismatic cellular structure, preferably square cross section, all of whose facets (walls, baseplate and top head) are heavily insulated to minimize loss of heat to the environment.

The Green Boiler tube bundle can be engineered with sufficient heat transfer surface area to absorb an amount of heat from the thermal mass composition produce superheated steam on demand to make electricity, or provide steam for other uses such as electrolysis (to make hydrogen) or to be used in an industrial process.

The nuclear steam supply system 105, will now be described in further detail. The nuclear steam supply system 100 in one embodiment comprises a small modular reactor (SMR) generally including a nuclear reactor 120 fluidly coupled to a steam generator 110. The reactor 120 includes a reactor pressure vessel (RPV) which contains a fuel core comprising nuclear fuel. The RPV contains an inventory of primary coolant which circulated through the steam generator 110 to transfer enthalpy from the reactor 120 to a working fluid loop 130 that comprises the steam generator 110 and an electricity generating system 150. A working fluid (liquid water) is heated by the hot primary coolant from the RPV heated by the fuel core and converted to steam. In the exemplified embodiment, the working fluid loop 130 is configured to circulate the working fluid through the thermal energy storage vessel 300 to absorb thermal energy from the thermal mass composition M and heat the working fluid for introduction to the electricity generating system 150.

In the exemplified embodiment, the primary coolant flows in a closed primary coolant flow loop between the steam generator 110 and RPV of the nuclear reactor 120 and is internal to the steam generator and RPV. The primary coolant flow loop is fluidly isolated from the second working fluid (water) flowing through the steam generator 110.

The working fluid loop 130 may further comprise flow conduits 135 that connect the various subcomponents in the working fluid loop 130 (i.e. the steam generator 110 and the electricity generating system 150). The flow conduits 135 are pathways and connectors through these subcomponents and may comprise piping, pumps (such as boiler feedwater pump 156), turbomachinery (such as compressors 136), and valves 137 which facilitate the flow of the working fluid through the working fluid loop.

Referring more specifically to the electricity generating system 150, it may include, without limitation, a conventional steam turbine-generator set including steam turbine 151, electric generator 152 mechanically coupled thereto and operably connected to the electric power grid, steam condenser which condenses the steam into condensate, and boiler feedwater pump 156. These components (excluding the generator of course) form integral fluidic parts of the working fluid loop 130 along with the heat exchanger 311 if the thermal energy storage vessel 300 of which conveys the working fluid therethrough to absorb heat from the thermal mass composition M to produce steam which runs the steam turbine-generator set to generate electricity. The generator produces electricity in a conventional manner via a stator and rotor assembly well known in the art. The feedwater pump 156 circulates the boiler feedwater through the working fluid loop 130 formed in part by flow conduits 135 which fluidly couple the water bearing components of the Rankine cycle and thermal energy storage vessel 300 together as shown. With exception of the present thermal energy storage vessel 300, the remaining balance of plant components of the clean energy Rankine cycle necessary to form a complete power generation system may be provided and operate in the same foregoing and well-known manner as traditional Rankine cycle components to produce electricity.

The solar energy collector system 400 will now be described in greater detail. In the exemplified embodiment, the solar energy collection system 400 comprising a heat transfer loop 430 including a first solar collector 411 configured to absorb solar energy and heat a heat transfer fluid. The heat transfer loop is configured to circulate a heat transfer fluid that is heated through the thermal energy storage vessel 300 and to add thermal energy to the thermal mass composition M in the thermal energy storage vessel 300.

The heat transfer loop 430 comprises flow conduits 435 that connect the various subcomponents in the heat transfer loop 430 and flow the heat transfer fluid from the solar energy collector system 400 to the thermal energy storage vessel 300. As with the flow conduits of the working fluid loop 130, the flow conduits 435 are pathways and connectors through these subcomponents and may comprise piping, pumps, turbomachinery, and valves which facilitate the flow of the working fluid through the working fluid loop 130.

The solar energy collection system may comprise a heliostat field 420 configured to reflect incoming solar energy to the first solar collector 411. In the exemplified embodiment, the heliostat field 420 surrounds the nuclear facility 100 and lies within the exclusion zone 200 and is comprised of a plurality of heliostats 421. The heliostat field 420 may partially or fully encircle the first solar collector 411 which receives thermal energy delivered to it by heliostats 421. Each heliostat 421 of the heliostat field 420 generally includes a support frame 422 typically mounted on the ground (or another available support surface) and an adjustable reflector 423 configured to capture and reflect incident solar radiation or light. The reflectors 423 in one embodiment may each be formed by a concave mirror with radius of curvature set to focus solar energy incident on its surface onto a first receiver 413 mounted on upper portion of the first solar collector 411. The first receiver 413 may be positioned at multiple elevations in along the first solar collector 411 so that radiant heat energy of the sun can be more effectively captured from the heliostat field 420.

The first receiver 413 is an integral fluidic part which serves to convey the received thermal energy from the sun to the thermal energy storage vessel 300 which in turn is interfaces with the electricity generation system 150 of the nuclear steam supply system 105. In the exemplified embodiment, the first receiver 413 is a heat exchanger with heat exchange tubes which serve as the entry points for the thermal energy input into the solar energy collection system, which heats the recirculating first working fluid to a desired target temperature.

In the illustrated embodiment, the solar energy system 400 comprises at least one photovoltaic field 430 comprising a plurality of photovoltaic solar cells 431. The photovoltaic field 430 is also located entirely within the exclusion zone 200. They may be located between the heliostat field 420 and the first solar collector 411 or they may be located in an available space not occupied by the heliostat 420, the first solar collector, or the nuclear steam supply system 100. The photovoltaic solar power system 430 may generate approximately 50 MWh (av) DC power during daylight hours which can be dispatched to grid in addition to the electricity generated by the nuclear steam supply system 105 or used to meet the nuclear steam supply system's 105 DC power needs such as charging batteries within the nuclear steam supply system 105.

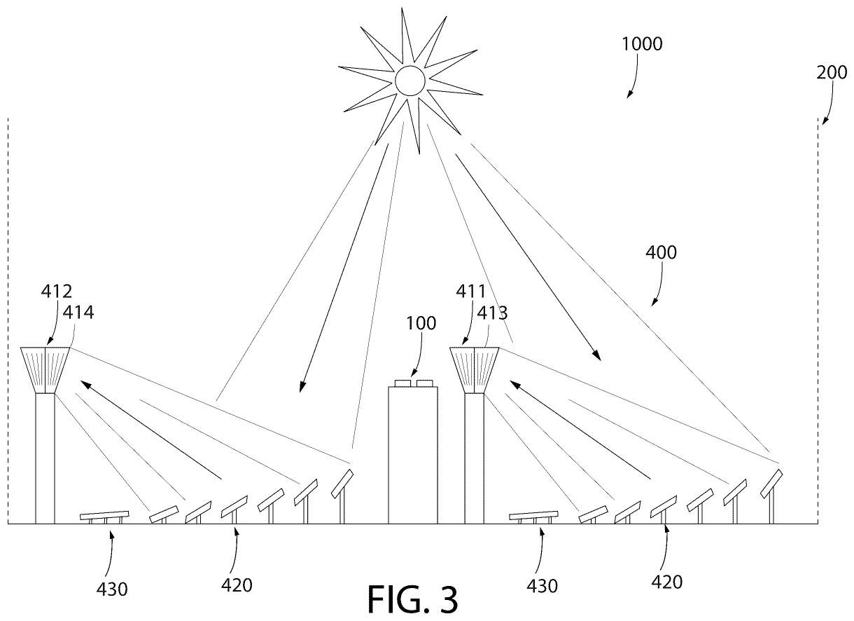

In the embodiment illustrated in FIGS. 2-3, the solar energy collection system 400 may also comprises a second solar collector 412 with a second receiver 414. In this embodiment, the second solar collector 412 and the second receiver 414 are structurally and functionally similar such that the description of the features of the first solar collector 411 and the first receiver 413 are application to the second solar collector 412 and second receiver 414. As shown in FIGS. 2-3, the first solar collector 411 is located radially inward of the heliostat field 420. It may further be located centrally within the exclusion zone 200. The second solar collector 413 may be located radially outward radially outward of the heliostat field 420. The second solar collector 413 may also be peripherally within the exclusion zone 200. Thus, if the heliostat field 430 is semi-circular, the first solar collector 411 and the second solar collector 413 optimally use the space within the exclusion zone 200.

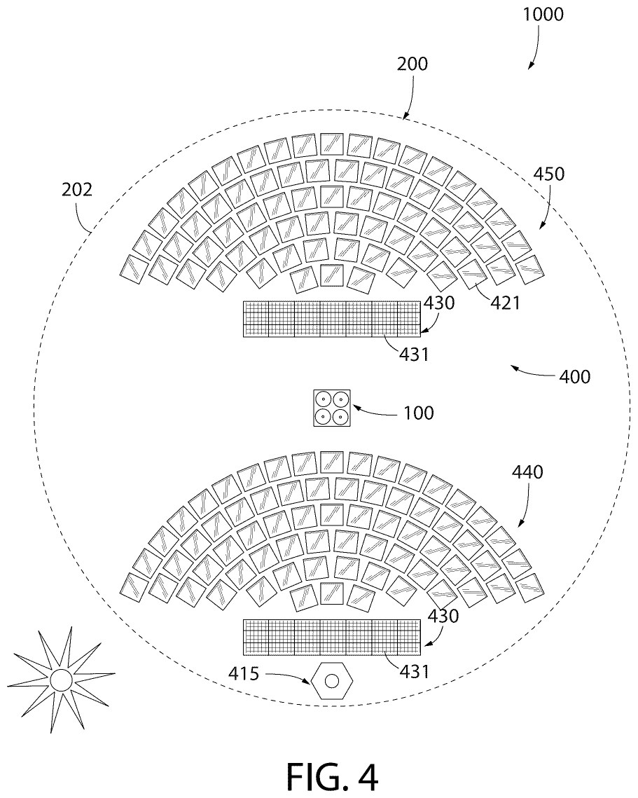

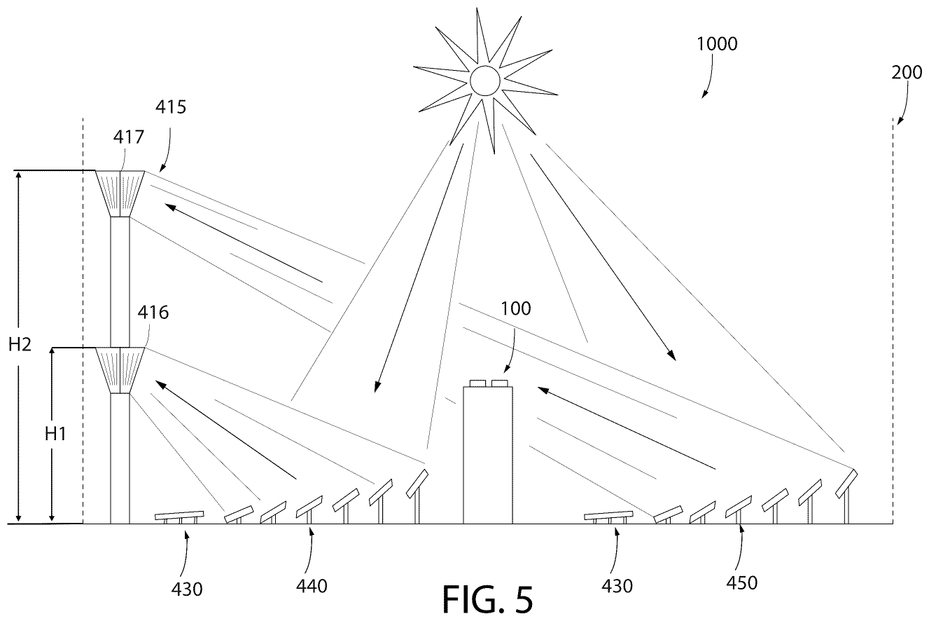

In another embodiment shown in FIGS. 4-5, the hybrid power generation system 1000 may comprise a solar energy collection system 400 may comprise a tower 415 comprising a first receiver 416 and a second receiver 417. The tower 415 may be located on perimeter 202 of the exclusion zone 200. In such an embodiment, the first receiver 416 and the second receiver 417 share the same features as first receivers 411 of the first solar collector 411 and the second receiver 414 of the second solar collector 412. The first receiver 416 and the second receiver 417 of the tower 415 are configured to receive solar energy and heat the heat transfer fluid. In the illustrated embodiment, the first receiver 416 is located at a first height H1 along the tower 415 and the second receiver 417 located at a second height H2 along the tower 415. In the exemplified embodiment, H2 is greater than H1. More specifically, H2 may be between 16 meters and 32 meters while H1 may be between 12 meters and 18 meters. Thus, portions of the heliostat field 420 that are more proximate to the tower 415 are angled to reflect sun to the first

In the embodiment shown in FIGS. 4-5, the solar energy collection system 400 comprise a first heliostat field 440 and a second heliostat field 450. As with the heliostat field 420, the first heliostat field 440 and the second heliostat field 450 heliostat field are configured to reflect incoming solar energy. Both the first heliostat field 440 and the second heliostat field 450 are comprised of individual heliostats 421, whose structure is described above in reference to the heliostat field 420. In this embodiment, the first heliostat field 440 is located more proximately to the solar collection tower 415 compared to the second heliostat field 450. Thus, the heliostats 421 of the first heliostat field 440 are angled such that they reflect sunlight to the first receiver 416 of the solar collector tower 415, and the heliostats 421 of the second heliostat field 450 are angled such that they reflect sunlight to the second receiver 417 of the solar collector tower 415.

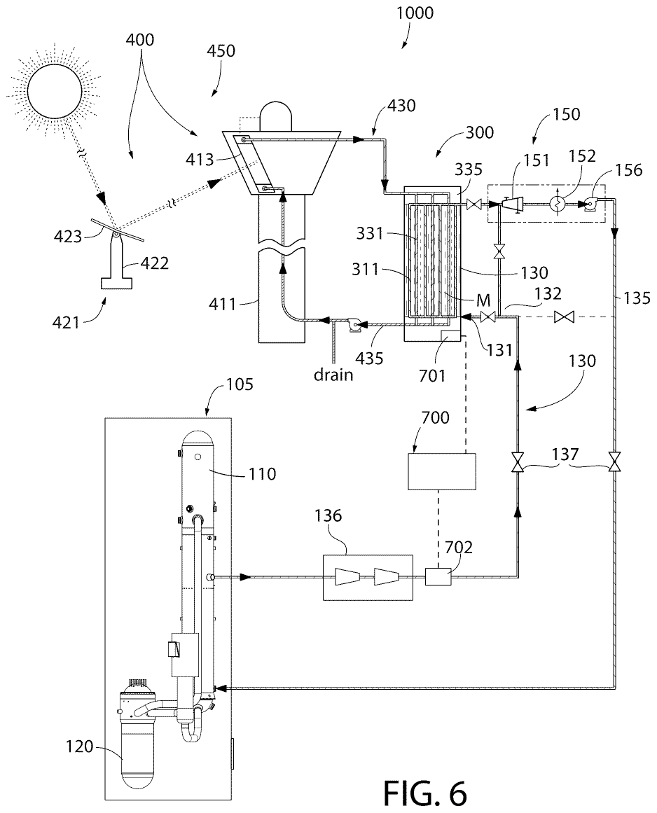

Referring now to the hybrid power generation system as a whole, FIG. 6 shows a schematic flow diagrams showing the hybrid power generation system 1000 according one embodiment of the present disclosure. The hybrid system power system 1000 may include a Rankine steam power cycle which derives input energy from solar thermal energy capture in lieu of fossil fuels to generate the steam necessary to produce electricity. The descriptions of the nuclear steam supply system 105, thermal energy storage system 300, and solar energy collection system 400 as described for the embodiments above are applicable to the embodiment described below.

FIG. 6 illustrates a schematic view of one embodiment of the present invention. In such an embodiment, the hybrid power generation system 1000 comprises the nuclear system supply system 105, the thermal energy storage vessel 300, an alternative energy collection system 450, and a control system 700. The alternative energy collection system 450 is configured to collect an alternative energy and transfer the alternative energy to the thermal mass composition in the thermal energy storage as thermal energy to heat the thermal mass composition. In the exemplified embodiment, the alternative energy collection system 450 is a solar energy collection system 400 as discussed above in the preceding paragraphs. However, the alternative energy collection system may be any other suitable power generating system that can transfer thermal energy to the thermal mass composition M in the thermal energy storage vessel 300. Examples include, but at not limited to, a geo-thermal power plant, a solar energy power plant, a wind energy power plant, or a hydroelectric power plant.

In the illustrated embodiment, the working fluid loop 130 of the nuclear steam supply system further comprises heat transfer line 131 that is located within the thermal energy storage vessel 300 and a bypass line 132 that bypasses the thermal energy storage vessel 300. Both the heat transfer line 131 and the bypass line 132 are comprised of the flow conduits 135 as described above. The bypass line 132 is configured to deliver the working fluid of the working fluid loop 130 directly to the electricity generating system 150 without passing through the thermal energy storage vessel 300.

The embodiment illustrated in FIG. 6 further comprises a control system 700 that is configured to change how the working fluid flows through the working fluid loop 130. The control system 700 may be either a manual control system, an automated control system 700 operated entirely electronically, or a hybrid manual-automatic control system. The control system 700 may comprise a first thermocouple 701 configured to measure the temperature of the working fluid loop 130 in the heat transfer line 131 located within the thermal energy storage vessel 300 and a second thermocouple 702 located upstream of the thermal energy storage vessel, but downstream of the steam generator 110.

In the illustrated embodiment, the control system 700 is configured to switch flow of the working fluid from the heat transfer line to 131 the bypass line 132 upon detecting that the working fluid would lose thermal energy to the thermal mass composition M and power generation by the electricity generating system 150 is needed. The control system 700 is also configured to switch flow of the working fluid from the bypass line 132 to the heat transfer line 131 upon determining, via temperature readings from the first thermocouple 701 and the second thermocouple 702: (i) that the working fluid would gain thermal energy from the thermal mass composition; or (ii) that the working fluid would lose thermal energy to the thermal mass composition and power generation by the electricity generating system 150 is not needed or can be adequately sustained with the working fluid exiting the thermal energy storage vessel 300 in a reduced enthalpy state.

For example, if the hybrid power generation system 1000 is being operated during the evening or night, a time where demand for electricity peaks and energy from solar radiation is not available, the control system 700 may divert the flow of the working fluid from the heat transfer line 131 to the bypass line 132 to avoid losses in enthalpy in the working fluid to the thermal mass composition M in the thermal energy storage vessel. In an alternative example, if electricity demand is lower than the maximum output of the electricity generating system 150, the control system 700 may divert the working fluid from the bypass line 132 to the heat transfer line 131 to add energy to the thermal mass composition M of the thermal energy storage vessel 300 for later use.

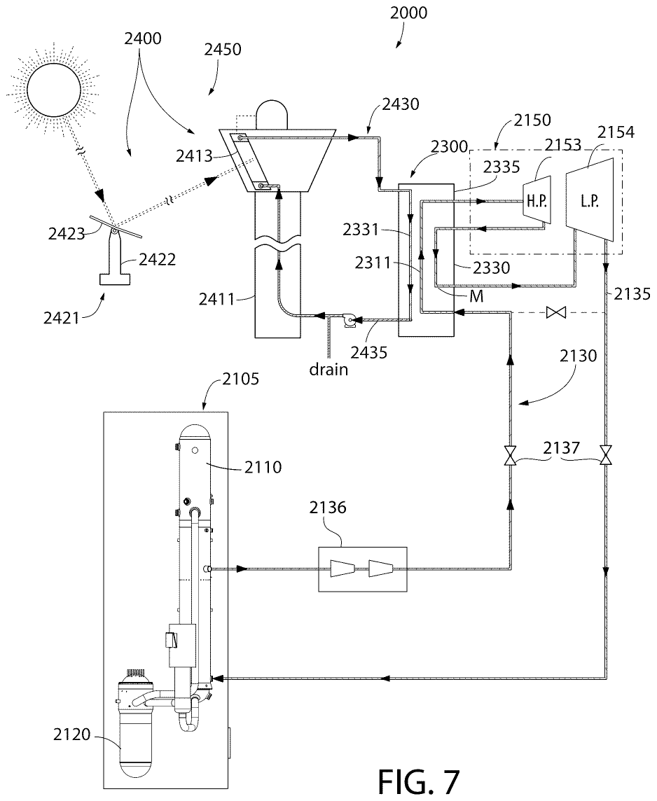

FIG. 7 illustrates another example of the present invention, a hybrid power generation system 2000. The components of the hybrid power generation system 2000 that are shared with the hybrid power generation system 1000 are renumbered with a preceding 2. Unless otherwise stated, these components share the same descriptions are their counterparts in the hybrid power generation system 1000.

In the hybrid power generation system 2000, the electricity generating system 2150 may comprise a high-pressure turbine 2153 and a low-pressure turbine 2154. In such an embodiment, the working fluid loop 2130 is configured to circulate the working fluid from the steam generator 2110 to the thermal energy storage vessel 2130 to superheat the working fluid before introduction to the high-pressure turbine 2153. The working fluid loop 2130 then recirculates the working fluid from the outlet of the high-pressure turbine 2153 through the thermal energy storage vessel 2130 again to reheat the working fluid before it is introduced to the low-pressure turbine 2154. Thus, the thermal energy storage vessel 2130 acts as moisture separator reheater which uses the high enthalpy heat stored in the thermal energy storage vessel 2130 to superheat the working fluid to increase the overall efficiency of the electricity generating system 2150.

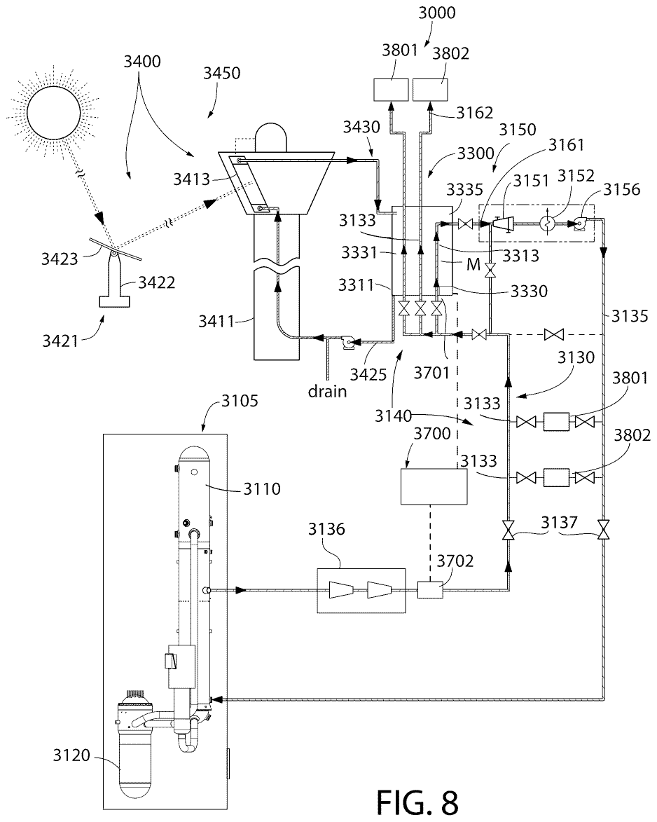

FIG. 8 illustrates embodiment of the invention, a hybrid power generation system 3000. The components of the hybrid power generation system 3000 that are shared with the hybrid power generation system 1000 and the hybrid power generation system 2000, but are renumbered with a preceding 3. Unless otherwise stated, the components of the share the same descriptions are their counterparts in the hybrid power generation system 1000.

The hybrid power generation system comprises a working fluid loop 3130 which may also be split into multiple streams at a flow splitter 3140, diverting some of it for other purposes such as production of hydrogen fuel or other industrial applications. In other words, the superheating of the working fluid in the thermal energy storage vessel can be carried out on the entire flow or one or more portions of it. Depending on how the entirety of the nuclear steam supply system's 3105 steam will be utilized each of the split steam flow can be conditioned to the thermodynamic state aligned with its intended purpose in the thermal energy storage vessel 3300 before exiting it.

In the exemplified embodiment, the flow splitter 3140 is a junction configured to divide flow of the working fluid downstream of the steam generator 3110 but upstream of the thermal energy storage vessel 3300 into a first working fluid stream 3161 and a second working fluid stream 3162. In the exemplified embodiment, the flow spitter 3140 is structured as a branching structure, but may also be structured as a T-shaped junction, Y-shaped junction, or any other structure that can split the flow of the working fluid in the working fluid loop 3130. The flow splitter 3140 may further comprise valves 3137 which are configured to open and close to enable the splitting of the working fluid into the first working fluid stream 3161, the second working fluid stream 3162, or any other stream that may be part of the flow splitter 3140.

The working fluid loop 3130 may further comprise an a first heat transfer line 3131 and at least one auxiliary line 3133. The first heat transfer line 3131 is configured to receive the first working fluid stream 3161 and flow the first working fluid stream 3161 through a thermal energy storage vessel 3300 so that the first working fluid stream 3161 absorbs thermal energy from the thermal mass composition M and delivers the first working fluid stream 3161 from the thermal energy storage vessel 3300 to an electricity generating system 3150.

The auxiliary line 3133 is a second heat transfer line that is configured to receive the second working fluid stream 3162 and flow the second working fluid stream 3162 through the thermal energy storage vessel 3300 to absorb thermal energy from the thermal mass composition M. The auxiliary line 3133 is then configured to deliver the second working fluid stream to an auxiliary system 3800 after exiting the thermal energy storage vessel 3300. This auxiliary system 3800 may be a variety of systems including a hydrogen fuel generation system 3801 or other industrial system that utilizes high pressure steam 3802.

The working fluid loop 3130 is further configured to condition the working fluid within each of the first working fluid 3161 and the second working fluid stream 3162 such that the working fluid in first working fluid stream 3161 is at a first thermodynamic state when it exits the thermal energy storage vessel 3300 and the working fluid in the second working fluid stream 3162 exits the thermal energy storage vessel 3300 at a second thermodynamic state that is different than the first thermodynamic state. The working fluid's thermodynamic state is determined by it's state variables such as temperature, pressure, volume, and enthalpy. So, for example, the first working fluid stream 3161 may exit the thermal energy storage vessel 3330 with a different temperature or enthalpy than the second working fluid stream 3162.

To facilitate this function, the hybrid power generation system 3000 may further comprise a control system 3700. The control system 3700 may further comprise and control valves 3137 and flow conduits 3135 which are configured to both allow and disallow the splitting the of the working fluid in the flow splitter 3140 and condition the working fluid within each of the first working fluid 3161 and the second working fluid stream 3162. For example, the control system 3700 may utilize components within the flow conduits 3135 to increase the flow rate of the working fluid through the first working fluid stream 3161 and the second working fluid stream 3162 or pass the working fluid through the first working fluid stream 3161 or the second working fluid stream 3162 multiple times. Thus, the working fluid can be conditioned for different applications via the thermal energy storage vessel 3330.

### Example Fossil Fuel Power Plant Conversion

There is a worldwide drive to close coal-fired power plants to protect the environment from further degradation. Against the environmental urgency to shut down coal-fired power plants which collectively produce over half of global power output and substituting them with clean energy installations stands a formidable economic challenge which is the staggering sum of money required to make the transition. The capital required is so immense that to convert from “coal to clean” would wreak havoc on the economies of many developing countries and threaten their social stability. Simply stated, to bring about the transition to clean energy generation in the developing world without massive economic disruption is the challenge that requires carefully-constructed government policy. The approach espoused in this bulletin consists of converting the coal-fired plant sites into “clean energy islands” by utilizing nuclear power and solar energy synergistically. In particular, it is proposed to re-purpose the coal powered plant sites as clean energy assets centered around a safe small modular reactor, such as the SMR-300, with an important supporting role played a hybrid solar power plant. The hybrid solar power plant combines a CSP (Concentrated Solar Energy) System comprising a heliostat field, power tower with thermal receivers circulating a heat transfer fluid (e.g., molten salt or heat transfer oil such as Dowtherm) through a thermal energy storage apparatus (e.g., Green Boiler) with one or more PV (photovoltaic) arrays which generate electric power directly. The aim is a symbiosis of nuclear and solar with the latter making nuclear power generation even more resilient and rendering the “clean energy island” into a “black-start” and “island mode” capable; i.e., a completely autonomous power generation facility. This solution would preserve the jobs and communities centered around the existing coal plant sites. The local employment levels at the repurposed site is actually estimated to triple as would the total amount of power produced accruing significant benefits to the local communities.

The following paragraphs as an example of a coal-to-clean energy conversion process. The coal-to-clean concept envisages the installation of a SMR-300 small modular reactors at the decommissioned coal plant site which are typically quite large, occupying 50 to 100 acres per 100 Mwe of generation capacity. Because the SMR-300 reactor is quite compact in its land requirement, Holtec's strategy involves dismantling the coal boiler, bag house, coal yard, turbogenerator and its associated equipment and repurposing the cleared land by installing SMR-300 nuclear reactors (320 MWe (net), 1050 MWt). As the SMR-300 reactors land requirement is quite modest (˜30 acres with water cooling or 40 acres with air cooling for a pair of reactors) the cleared land could accommodate multiple SMR-300 reactors. A coal site may be re-purposed with twin SMR-300 reactors each producing 320 MWe thus yielding combined 640 MWe capacity. The remaining land which varies from site to site may be suitably deployed to harness the solar energy incident on it using hybrid solar energy plant equipped with a thermal energy storage vessel such as a Green Boiler thermal energy storage system. The amount of available land and the location of the plant site (i.e., its latitude) would inform the amount of solar energy that can be harnessed from it. As discussed in [1], the hybrid concentrated solar power plant employs both the concentrated solar system which along with the Green Boiler provides steam on-demand as well as DC power from the photovoltaic panels. Both the steam and DC power can be deployed to improve the resiliency and power output of the nuclear plant.

Thus, the hybrid concentrated solar power plant can be suitably configured to accomplish a variety of tasks. First, if the available land is large, the hybrid concentrated solar power plant can be used to produce electricity by employing Photovoltaic modules (PVMs) and/or using its concentrated solar power plant portion to produce high pressure steam to drive a turbo-generator. Second, store thermal energy in the Green Boiler to generate steam at the desired temperature and pressure to provide steam required by the nuclear plant as a substitute for the diesel-powered “aux boiler.” Third, deploy Green Boiler to boost the superheat of the reactor steam and concomitant power output during peak hours. Fourth, replace the Moisture Separator Reheater in the SMR-300's power cycle and use the high enthalpy heat stored in the Green Boiler to superheat the cycle steam. Fifth, utilize the reactor steam or partially expanded cycle steam to help start up the hybrid solar power plant from cold condition when the solar salt is apt to be frozen.

Because a coal-fired plant will typically have a much larger land area compared to that required by the SMR-300 plant, the new nuclear facility will use only a portion of the available land. The freed-up land can be productively deployed by installing Concentrated Solar Plant to capture the Sun's energy. As an example, if a coal plant on, say, 300 acres of land is converted to a clean energy facility, the energy profile of the repurposed site will be as follows.

Twin SMR-300 Reactors will occupying 40 acres of land (that use air cooled condensers for waste heat rejection) will produce a total of 640 MW baseload power. The remaining 260 acres (solar field) is deployed to install hybrid concentrated solar plant consisting of PV panels and heliostats as previously described. PV panels will generate approximately 50 MWh (av) DC power during daylight hours which can be dispatched to grid or used to meet the nuclear plant's DC power needs such as charging the nuclear plant's batteries. The concentrated solar portion of the plant computes to capture as much as 1560 MWh thermal energy which can be stored in the Green Boiler. The stored thermal energy can be used for round-the-clock (RTC) power generation yielding 25 MW or used for on-demand power or used to replace the nuclear plant's Moisture Separator Reheator (MSR) simplifying the steam cycle of the power plant (no MSR drains and associated piping, valves, etc. to contend with). The SMR-300 plant conjugated with the hybrid concentrated solar power plant will be capable of starting without off-site power, will have process steam as needed to operate valves and controllers as needed and eliminate the nuclear plant's reliance on any external source of auxiliary power.

According to one aspect of the invention, the hybrid power generation system 1000 disclosed herein can be used to retrofit and re-purpose existing fossil fuel power plants (e.g., coal, lignite, oil, or gas) which contribute to greenhouse gas emissions. The existing steam generation systems in such plants which combust fossil fuels to produce the steam that powers the Rankine cycle can be replaced with a combination of the nuclear steam supply system 105 and thermal energy storage vessel 300 disclosed herein. Both the nuclear steam supply system 105 and thermal energy storage vessel 300 are required since the enthalpy of steam output from an SMR (smaller modular reactor) is typically modest and insufficient to power the energy conversion system of a fossil fuel power plant without the boost in enthalpy of the steam from the green boiler. The energy conversion system, which includes the steam turbine-generator set, condenser, feedwater pumps, etc., can advantageously be retained and re-used. Once retrofit, the prior fossil fuel power plant can continue to generate power in a more environmentally “green” manner without carbon emissions.

In this section, calculations are undertaken illustrating hybrid plant performance enhancements by retrofitting the fossil fuel plant as described above. For this purpose, a coal fired power plant example is used. In this example, a coal plant turbogenerator (turbine generator set) is repowered with steam from two smaller modular reactors such as two SMR-300 available from Holtec International of Camden, New Jersey. The hybrid plant is designed and configured to increase the enthalpy of the SMR steam by incorporating the thermal energy storage vessel 300 to boost the enthalpy of steam and concomitantly enhance the turbogenerator power output (i.e. megawatts or MW).

A process or method for converting a fossil fuel power generation system to a clean energy power generation system can therefore be summarized at a high level as including: replacing a fossil-fuel steam supply system which derives energy from fossil fuels with a nuclear steam supply system; generating steam having first thermodynamic conditions in the nuclear steam supply system; adjusting one or more parameters of the steam at the first thermodynamic conditions to yield steam at second thermodynamic conditions; and retaining an energy conversion system of the fossil-fuel power generation system which comprises a steam turbine-generator set operable to generate electricity; wherein the steam turbine-generator set receives steam at the second thermodynamic conditions.

Features of the hybrid power generation system may be summarized as follows.

A hybrid power plant that converts the nuclear steam supply system steam to a higher enthalpy steam by conjugating it with a thermal energy storage vessel 300 such as a green boiler equipped to store intermittently available heat energy delivered to it by a solar collector, or electric power from the electric power grid or a wind turbine farm proximate to the green boiler.

The high-pressure steam can be used in any desired application such as making electricity on demand or providing steam continuously to make power or making hydrogen or serving as process steam for an industrial application.

A bottoming cycle known as the Goswami cycle disclosed in Chapter 7: The Goswami cycle and its applications”, G. Demirkaya, M. Levini, R. V. Padilla, and D. Yogi Goswami. Published January 2022, IOP Publishing Ltd, 2021, may be added to the system to extract an additional approximately 5-6% power from the power generating plant and also serving a space cooling function.

While the foregoing description and drawings represent exemplary embodiments of the present disclosure, it will be understood that various additions, modifications and substitutions may be made therein without departing from the spirit and scope and range of equivalents of the accompanying claims. In particular, it will be clear to those skilled in the art that the present invention may be embodied in other forms, structures, arrangements, proportions, sizes, and with other elements, materials, and components, without departing from the spirit or essential characteristics thereof. In addition, numerous variations in the methods/processes described herein may be made within the scope of the present disclosure. One skilled in the art will further appreciate that the embodiments may be used with many modifications of structure, arrangement, proportions, sizes, materials, and components and otherwise, used in the practice of the disclosure, which are particularly adapted to specific environments and operative requirements without departing from the principles described herein. The presently disclosed embodiments are therefore to be considered in all respects as illustrative and not restrictive. The appended claims should be construed broadly, to include other variants and embodiments of the disclosure, which may be made by those skilled in the art without departing from the scope and range of equivalents.

1. A hybrid power generation system comprising:
a nuclear facility comprising a nuclear reactor and an exclusion zone;
a thermal energy storage vessel located within the exclusion zone, the thermal energy storage vessel defining an internal space containing a thermal mass composition operable to store thermal energy;
a nuclear steam supply system located within the exclusion zone and comprising the nuclear reactor and a working fluid loop, the working fluid loop comprising a steam generator, and an electricity generating system, the working fluid loop configured to circulate a working fluid from the steam generator through the thermal energy storage vessel to absorb thermal energy from the thermal mass composition and heat the working fluid for introduction to the electricity generating system; and
a solar energy collection system located within the exclusion zone and comprising a heat transfer loop including a first solar collector configured to absorb solar energy to heat a heat transfer fluid, the heat transfer loop configured to circulate the heated heat transfer fluid through the thermal energy storage vessel to add thermal energy to the thermal mass composition in the thermal energy storage vessel.

2. The hybrid power generation system according to claim 1 wherein the exclusion zone is an area immediately surrounding the nuclear reactor that is under the authority of a reactor licensee.

3. The hybrid power generation system according to claim 1 wherein the solar energy collection system comprises a heliostat field, a plurality of heliostats located within the heliostat field and configured to reflect incoming solar energy to the first solar collector.

4. The hybrid power generation system according to claim 3 wherein the solar energy system further comprises a photovoltaic field located between the heliostat field and the first solar collector, a plurality of photovoltaic solar cells located within the photovoltaic field.

5. The hybrid power generation system according to claim 3 wherein the first solar collector is located radially inward of the heliostat field, the first solar collector comprising a first tower and a first receiver mounted to the first tower.

6. The hybrid power generation system according to claim 5 wherein the solar energy collection system further comprises a second solar collector located radially outward of the heliostat field, the second solar collector comprising a second receiver.

7. The hybrid power generation system according to claim 1 wherein the electricity generating system comprises a high-pressure turbine, and the working fluid loop is configured to circulate the working fluid from the steam generator to the thermal energy storage vessel and to superheat the working fluid before introduction to the high-pressure turbine.

8. The hybrid power generation system according to claim 7 wherein the electricity generating system further comprises a low-pressure turbine, and the working fluid loop is further configured to recirculate the working fluid from the outlet of the high-pressure turbine through the thermal energy storage vessel to reheat the working fluid before introduction to the low pressure turbine.

9.-15. (canceled)

16. A hybrid power generation system comprising:
a thermal energy storage vessel defining an internal space containing a thermal mass composition operable to store thermal energy;
an alternative energy collection system configured to collect an alternative energy and transfer the alternative energy to the thermal mass composition in the thermal energy storage as thermal energy to heat the thermal mass composition;
a nuclear steam supply system comprising a nuclear reactor and a working fluid loop comprising a steam generator and an electricity generating system, the working fluid loop configured to circulate a working fluid and comprising:
a heat transfer line having a portion located within the thermal energy storage vessel and in thermal communication with the thermal mass composition, the heat transfer line configured to deliver the working fluid that passes through the portion to the electricity generating system; and
a bypass line that bypasses the thermal energy storage vessel;
a control system configured to selectively switch the working fluid from flowing through the heat transfer line to flowing through the bypass line.

17. The hybrid power generation system according to claim 16 wherein the control system comprises a plurality of valves.

18. The hybrid power generation system according to claim 16 wherein the bypass line delivers the working fluid to the electricity generating system without passing through the thermal energy storage vessel.

19. The hybrid power generation system according to claim 16 wherein the control system is configured to switch flow of the working fluid from the heat transfer line to the bypass line upon detecting that the working fluid would lose thermal energy to the thermal mass composition and power generation by the electricity generating system is needed.

20. The hybrid power generation system according to claim 16 wherein the control system is configured to switch flow of the working fluid from the bypass line to the heat transfer line upon determining: (i) that the working fluid would gain thermal energy from the thermal mass composition; or (ii) that the working fluid would lose thermal energy to the thermal mass composition and power generation by the electricity generating system is not needed or can be adequately sustained with the working fluid exiting the thermal energy storage vessel in a reduced enthalpy state.

21. (canceled)

22. The hybrid power generation system according to claim 16 wherein the alternative energy collection system comprises a solar energy collection system comprising a heat transfer loop including a solar collector configured to absorb solar energy and heat a heat transfer fluid, the heat transfer loop configured to circulate the heat transfer fluid through the thermal energy storage vessel and heat the thermal mass composition in the thermal energy storage vessel.

23. A hybrid power generation system comprising:
a thermal energy storage vessel defining an internal space containing a thermal mass composition operable to store thermal energy;
an alternative energy collection system configured to collect an alternative energy and transfer the alternative energy to the thermal mass composition in the thermal energy storage as thermal energy to heat the thermal mass composition;
a nuclear steam supply system comprising a nuclear reactor and a working fluid loop comprising a steam generator and an electricity generating system, the working fluid loop configured to circulate a working fluid and further comprising:
a flow splitter configured to divide flow of the working fluid downstream of the steam generator but upstream of the thermal energy storage vessel into a first working fluid stream and a second working fluid stream;
a first heat transfer line configured to: (i) receive the first working fluid stream; (ii) flow the first working fluid stream through the thermal energy storage vessel so that the first working fluid stream absorbs thermal energy from the thermal mass composition; and (iii) deliver the first working fluid stream exiting the thermal energy storage vessel to the electricity generating system; and
an auxiliary line configured to receive the second working fluid stream.

24. The hybrid power generation system according to claim 23 wherein the auxiliary line is a second heat transfer line configured to: (i) receive the second working fluid stream; (ii) flow the second working fluid stream through the thermal energy storage vessel so that the second working fluid stream absorbs thermal energy from the thermal mass composition; and (iii) deliver the second working fluid stream exiting the thermal energy storage vessel to an auxiliary system.

25. The hybrid power generation system according to claim 24 wherein the first heat transfer line is configured to flow the first working fluid stream through the thermal energy storage vessel so that the first working fluid stream exiting the thermal storage vessel has a first thermodynamic state; and wherein the second heat transfer line is configured to flow the second working fluid stream through the thermal energy storage vessel so that the second working fluid stream exiting the thermal storage vessel has a second thermodynamic state that is different than the first thermodynamic state.

26. The hybrid power generation system according to claim 24 wherein the first heat transfer line is configured to flow the first working fluid stream through the thermal energy storage vessel to add a first amount of enthalpy to the first working fluid stream; and wherein the second heat transfer line is configured to flow the second working fluid stream through the thermal energy storage vessel to add a second amount of enthalpy to the second working fluid stream, the first and second amounts of enthalpy being different from one another.

27. The hybrid power generation system according to claim 24 wherein the first heat transfer line is configured to flow the first working fluid stream through the thermal energy storage vessel to increase temperature of the first working fluid stream by a first amount; and wherein the second heat transfer line is configured to flow the second working fluid stream through the thermal energy storage vessel to increase temperature of the second working fluid stream by a second amount, the first and second amounts being different from one another.

28. (canceled)

29. The hybrid power generation system according to claim 23 further comprising a control system configured to selectively allow or disallow the splitting of the flow of the working fluid into the first and second working fluid streams by the flow splitter.
